(19) United States
(12) Patent Application Publication
(10) Pub. No.: US 2007/0067619 A1
(43) Pub. Date: Mar. 22, 2007

(54) Authentication apparatus, authentication method, recording medium storing authentication program and computer data signal embodied in carrier wave

(75) Inventor: Takayuki Koyama, Tokyo (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/518,459

(22) Filed: Sep. 11, 2006

(30) Foreign Application Priority Data
Sep. 22, 2005 (JP) 2005-276279
Aug. 16, 2006 (JP) 2006-221905

(51) Int. Cl. H04L 9/00

(52) U.S. Cl. 713/155

(57) ABSTRACT

An authentication apparatus which, during processing a job which is initiated according to occurrence of an event and is performed based on an instruction sheet, implements the authentication processing required for processing the job, the apparatus includes a determination section that determines whether authentication is required for processing the job; a request section that, in case where the determination section determines that the authentication is required, requests a possessor of the job to input authentication information; a reception that, according to the request by the request section, receives the authentication information which is inputted by the possessor; and an implementation section that, on the basis of the authentication information which the reception receives, implements the authentication processing.

### BACKGROUND

1. Technical Field

The present invention relates to an authentication apparatus, an authentication method, a recording medium storing an authentication program and a computer data signal embodied in a carrier wave, and particularly, to an authentication apparatus, an authentication method, a recording medium storing an authentication program and a computer data signal embodied in a carrier wave which, during processing a job which is initiated according to the occurrence of a predetermined event, implements the authentication processing required for processing the job.

2. Related Art

In recent years, devices, such as a compound machine, and the like, have been provided with enhanced capabilities, and they are, in some cases, utilized as an apparatus constituting a system which, in cooperation with an external application service, a web service, or the like, automatically performs a variety of processings. Examples of such a processing include storing a facsimile-received image into a file server together with the sender ID (the pieces of information about the transmitting station, such as the phone number, and the like).

For such a series of automatic processings, an art which previously stores a type of batch command called an “instruction sheet” in the device, and initiates automatic processing, utilizing the event of reception of a scanning or facsimile signal, or the like, as a trigger is available.

In addition, as an art for carrying out automatic processing, such as batch job processing, or the like, a network system, and the like, which are adapted such that, even if the batch job processing takes a long period of time, the term of validity for the ticket required for performing the batch job will not expire is available.

### SUMMARY

According to an aspect of the present invention, there is provided an authentication apparatus which, during processing a job which is initiated according to occurrence of an event and is performed based on an instruction sheet, implements an authentication processing required for processing the job, the apparatus including: a determination section that determines whether authentication is required for processing the job; a request section that, in case where the determination section determines that the authentication is required, requests a possessor of the job to input authentication information; a reception that, according to the request by the request section, receives the authentication information which is inputted by the possessor; and an implementation section that, on the basis of the authentication information which the reception receives, implements the authentication processing.

### BRIEF DESCRIPTION OF THE DRAWINGS

Exemplary embodiments of the present invention will be described in detail based on the following figures, wherein

FIG. 1 is a diagram showing an example of configuration of a network system utilizing a device to which the present invention is applied;

FIG. 2 is a block diagram illustrating the functional configuration of a device 1 and a client 6;

FIG. 3 is a flowchart illustrating the flow of the operation of an instruction sheet engine 10;

FIG. 4 is a diagram illustrating the flow of information sent and received in implementation of an instruction sheet;

FIG. 5 is a flowchart illustrating the flow of the information sent and received in implementation of the instruction sheet;

FIGS. 6A and 6B give an example of contents of an authentication information request mail, and an example of display of the input page;

FIG. 7 is a diagram illustrating the flow of information sent and received in implementation of the instruction sheet in Exemplary Embodiment 2;

FIG. 8 is a drawing giving an example of pop-up display by an authentication agent;

FIG. 9 is a diagram illustrating the flow of information sent and received in implementation of the instruction sheet in case where the authentication information is set in the authentication agent; and

FIG. 10 is a flowchart illustrating the flow of the information sent and received in implementation of the instruction sheet in Exemplary Embodiment 3.

### DETAILED DESCRIPTION

Hereinbelow, exemplary embodiments of the authentication apparatus and method pertaining to the present invention will be described in detail with reference to the attached drawings.

### Exemplary Embodiment 1

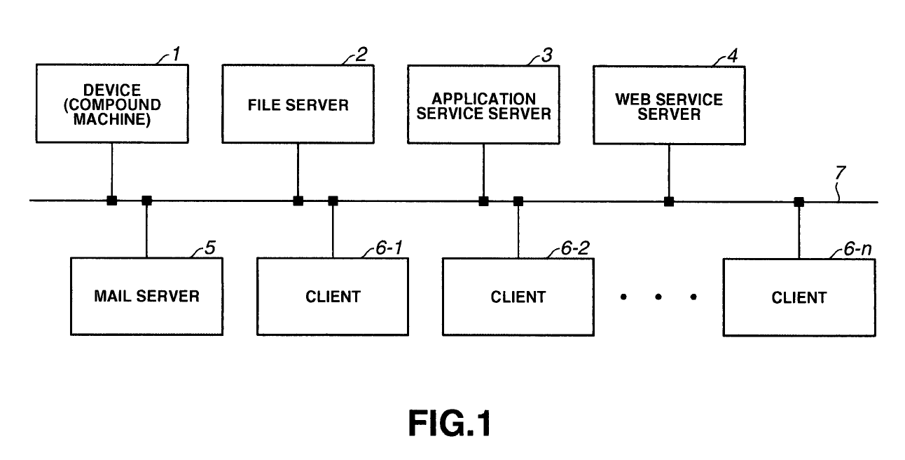

FIG. 1 is a diagram giving an example of configuration of a network system utilizing a device to which the present invention is applied. The network system as shown in the same figure is configured to include a device 1, a file server 2, an application service server 3, a web service server 4, a mail server 5, and a client 6 (6-1 to 6-n) which are connected to one another through a network 7.

The device 1 is a device to which the present invention is applied, and is, for example, a compound machine having a plurality of functions, such as facsimileing, scanning, printing, copying, and the like. In addition, the device 1 carries out a job processing, such as processing of storing a facsimile-received image in the file server 2, or the like, in accordance with an instruction sheet.

The file server 2 functions as a storage apparatus which is available through the network 7. The application service server 3 provides an application service for applying some processing to the data, such as a file, or the like. The web service server 4 carries out a service of providing a web page, or the like. The mail server 5 functions as a mail sending server as well as a mail receiving server, providing mail sending and mail receiving services. The client 6 is directly utilized by users of a personal computer, a portable terminal, or the like.

The network 7 not always represents a single network, and is used as a general term for a plurality of networks. Therefore, as the client 6, a portable telephone compatible with the Internet can also be utilized, and the application service server 3, the web service server 4, and the mail server 5 may be operated by different managers, respectively.

In this network system, the device 1 carries out a job processing in accordance with an instruction sheet. In this job processing, in case where there is the need for accessing the file server 2, the application service server 3, the web service server 4, and the like, and an authentication processing is required before accessing, authentication information is acquired from the user as designated in the instruction sheet, in other words, the possessor of the job, for utilization of the acquired authentication information for the authentication processing. The user who is the job possessor inputs the authentication information from the client 6.

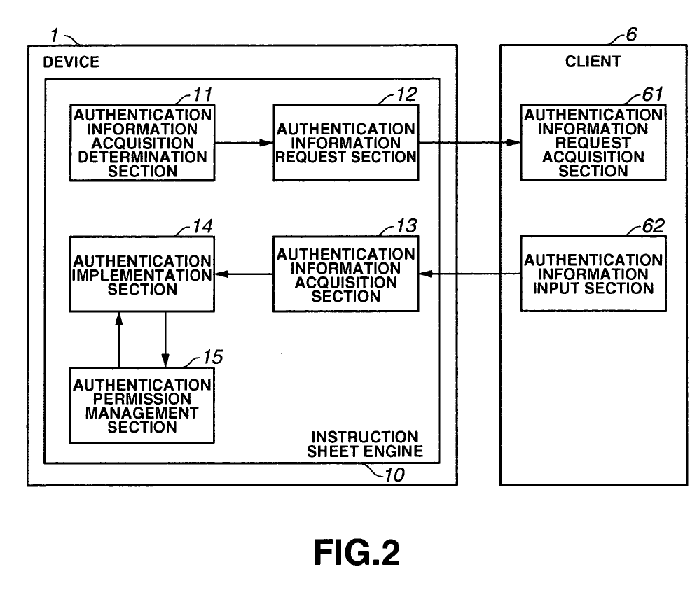

Herein, the details of the device 1 and the client 6 will be described. FIG. 2 is a block diagram illustrating the functional configuration of the device 1 and the client 6. In FIG. 2, only the functional sections related to processing of authentication information are shown, and the other functional sections are omitted to be shown.

The device 1 may be configured to include a calculation unit such as a CPU (Central Processing Unit), etc. and a memory such as a ROM (Read Only Memory), a RAM (Random Access Memory) or a nonvolatile memory and, by executing the program stored in the ROM or the nonvolatile memory, may be configured to realize function units relative to the processing of the authentication information shown in FIG. 2. This program makes the CPU, etc. realize the function units relative to the processing of the authentication information shown in FIG. 2, and can be distributed by being stored in various recording media.

As shown in the same figure, the device 1 has an instruction sheet engine 10 for implementing the instruction sheet, and the instruction sheet engine 10 is configured to include an authentication information acquisition determination section 11, an authentication information request section 12, an authentication information acquisition section 13, an authentication implementation section 14, and an authentication permission management section 15. The authentication permission management section 15 is not always a necessary component.

In addition, the client 6 is configured to include an authentication information request acquisition section 61, and an authentication information input section 62.

The instruction sheet engine 10 implements the job processing in accordance with the conditions for implementing the job as given in the instruction sheet stored in an instruction sheet storage section (not shown). Before the instruction sheet engine 10 implements the job processing, the authentication information acquisition determination section 11 determines whether there is the need for acquiring the authentication information. In case where the authentication information acquisition determination section 11 determines that there is the need for acquiring the authentication information, the authentication information request section 12 requests the user, the possessor of the job, to input the authentication information, in accordance with the method as specified in the instruction sheet.

When the authentication information request section 12 requests the authentication information to be inputted, the authentication information request acquisition section 61 receives the request, and promotes the user, the possessor of the job, to input the authentication information. In case where the authentication information request section 61 has received the input request for the authentication information, the authentication information input section 62 receives the input of the authentication information from the user, the possessor of the job.

The authentication information acquisition section 13 acquires the authentication information which has been inputted into the authentication information input section 62 by the user, the possessor of the job. The implementation section 14 implements the authentication processing, utilizing the authentication information which the authentication information acquisition section 13 has acquired. In case where the authentication information which has been utilized by the authentication implementation section 14 is to be subsequently utilized, the authentication permission management section 15 manages the authentication information as a ticket, and this ticket is utilized by the authentication implementation section 14 as needed.

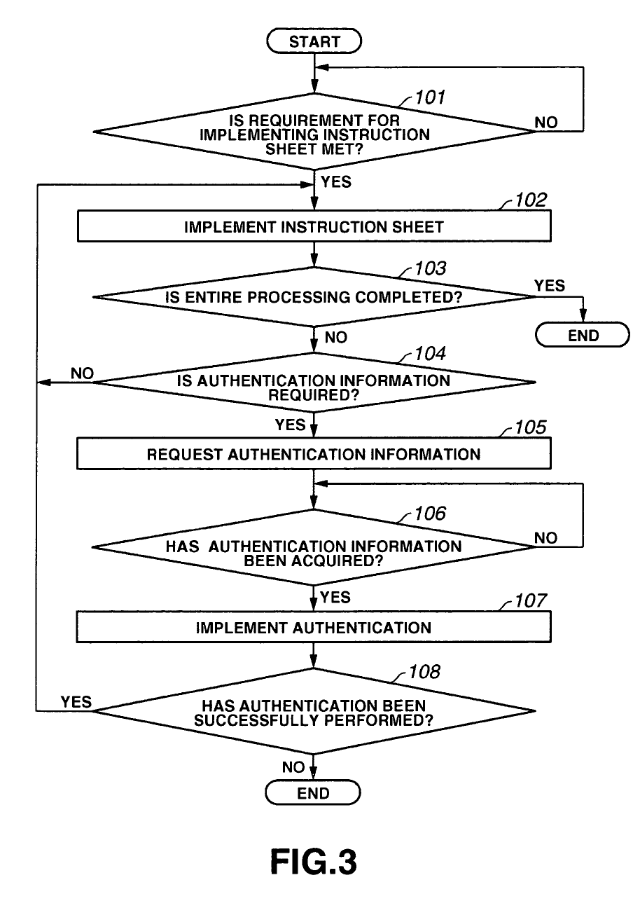

Next, the operation of the device 1 in case where the instruction sheet is to be implemented will be described. FIG. 3 is a flowchart illustrating the flow of the operation of the instruction sheet engine 10.

When there occurs an event which meets the requirement for implementing the instruction sheet, such as a facsimile reception (YES at step 101), the instruction sheet engine 10 implements the corresponding instruction sheet (step 102). And, when, during the implementation of the instruction sheet, the authentication information acquisition determination section 11 determines that there is the need for acquiring the authentication information (NO at step 103 and YES step 104), the authentication information request section 12 requests the user, the possessor of the job, to input the authentication information (step 105). And, when the authentication information acquisition section 13 acquires the authentication information which has been inputted by the user, the possessor of the job (YES step 106), the authentication implementation section 14 implements an authentication processing, for example, login processing into the file server 2 (step 107). And, when the authentication processing has been successfully performed (step 108), the instruction sheet engine 10 continues the implementation of the instruction sheet, and at the completion of the entire processing as specified in the instruction sheet (YES at step 103), the job processing on the basis of the instruction sheet is completed.

Next, the same processing will be described in terms of the relationship among the device 1, the client 6, and the like.

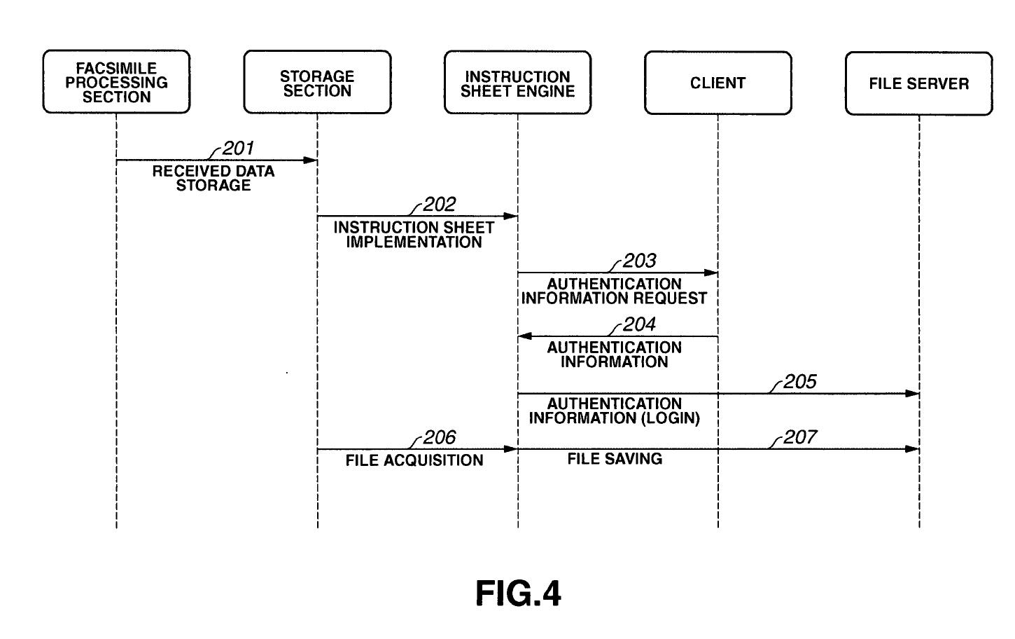

FIG. 4 is a diagram illustrating the flow of information sent and received in implementation of the instruction sheet.

In the device 1, when a facsimile processing section (not shown) receives an image, it stores, on the basis of the instruction of the sender thereof, the received data as a file in the storage region for the user in which a storage section (not shown) is provided (step 201). When this storage of the received data in the storage section meets the requirement for implementing a particular instruction sheet stored in an instruction sheet storage section (not shown) (one region of the storage section in which the received data has been stored), the instruction sheet engine 10 reads out the instruction sheet and implements the instruction sheet read out (step 202).

In the course of this implementation of the instruction sheet, when the authentication information acquisition determination section 11 determines that there is the need for acquiring the authentication information, the authentication information request section 12 requests inputting the authentication information of the client which is utilized by the possessor of the instruction sheet which is being implemented, i.e., the user, the possessor of the job (step 203). When, in response to this input request for the authentication information, the user, the possessor of the job, inputs the authentication information, the authentication information acquisition section 13 acquires this (step 204).

When the authentication information acquisition section 13 acquires the authentication information, the authentication implementation section 14 accesses the file server 2, and using the authentication information, logs into the file server 2 (step 205). When logging into the file server 2 has been successfully performed, the instruction sheet engine 10 acquires the received data stored as a file in the storage section (step 206), and stores the acquired file in the file server 2 (step 207).

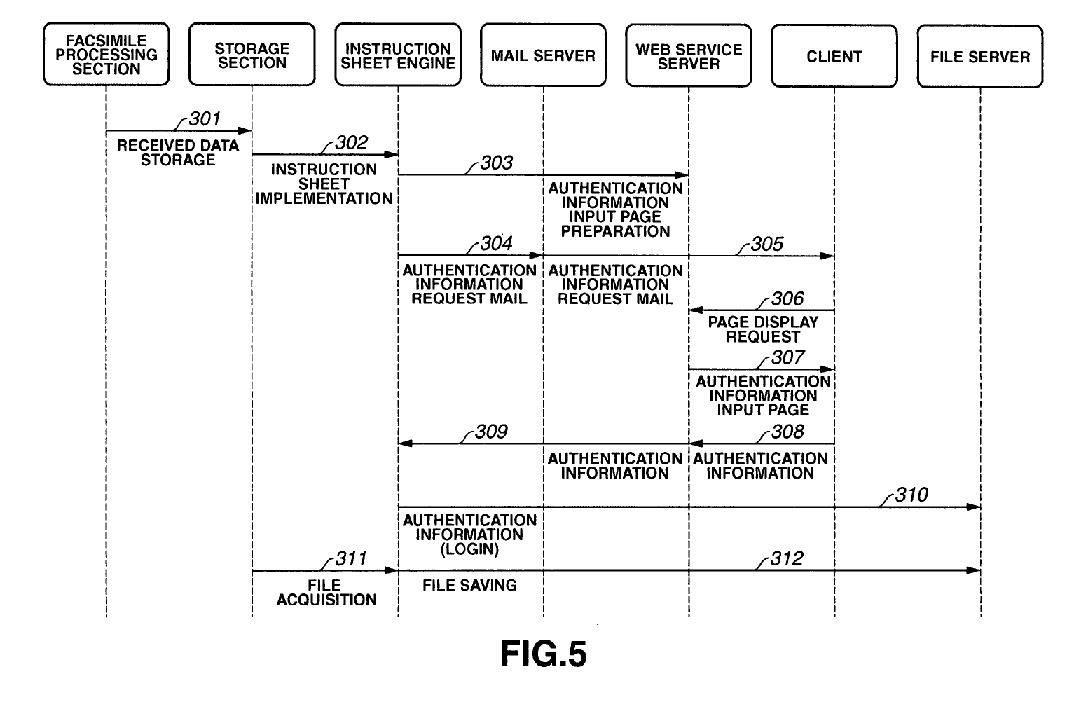

Next, about request for the authentication information by the instruction sheet engine 10, and input of the authentication information from the client 6, a specific example will be described. FIG. 5 is a flowchart illustrating the flow of the information sent and received in implementation of the instruction sheet.

In the device 1, when a facsimile processing section (not shown) receives an image, it stores, on the basis of the instruction of the sender thereof, the received data as a file in the storage region for the user in which a storage section (not shown) is provided (step 301). When this storage of the received data in the storage section meets the requirement for implementing a particular instruction sheet stored in an instruction sheet storage section (not shown) (one region of the storage section in which the received data has been stored), the instruction sheet engine 10 reads out the instruction sheet and implements the instruction sheet read out (step 302).

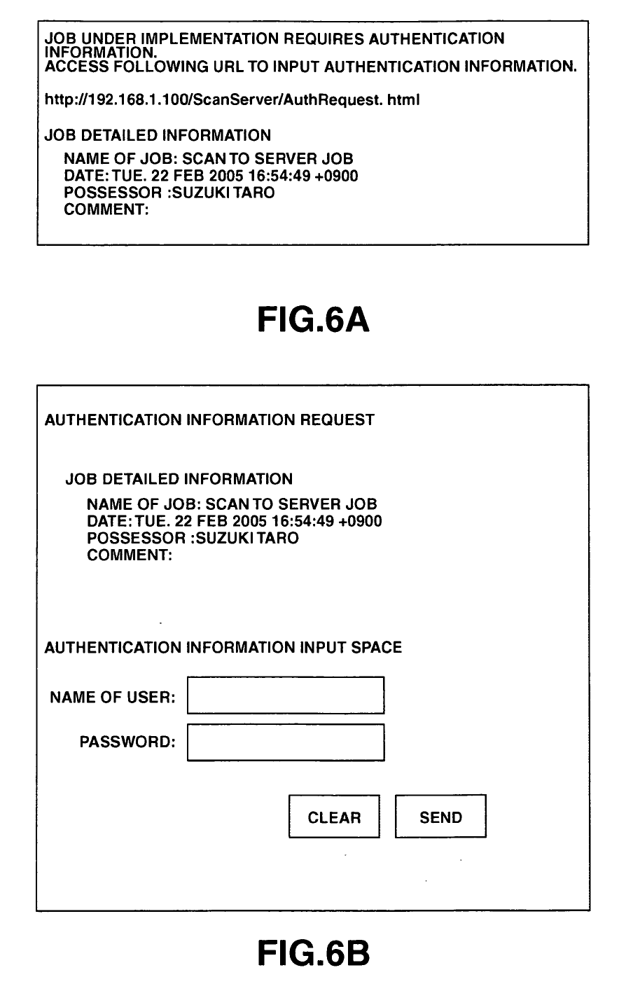

In the course of this implementation of the instruction sheet, when the authentication information acquisition determination section 11 determines that there is the need for acquiring the authentication information, the authentication information request section 12 first accesses the web service server 4 according to the statement in the instruction sheet, and prepares an input page for causing the authentication information to be inputted (step 303). And, an authentication information request mail giving the URL for the input page, for example, a mail having contents as shown in FIG. 6A is sent to the user, the possessor of the job. This authentication information request mail is sent to the mail server 5 (step 304), and received by the client 6 which is utilized by the user, the possessor of the job (step 305).

Then, at the client 6 which has received the authentication information request mail, when the user, the possessor of the job, accesses the web service server 4 according to the URL given in the authentication information request mail (step 306), the web service server 4 returns, to the client 6, the information about the input page for causing the authentication information to be inputted, and the client 6 displays that input page (step 307). The display of the input page includes the space for authentication information input, for example, that as shown in FIG. 6B.

To this input page, when the user, the possessor of the job, inputs the authentication information, the inputted authentication information is sent to the web service server 4 (step 308), and transferred to the authentication information acquisition section 13 (step 309).

When the authentication information acquisition section 13 acquires the authentication information, the authentication implementation section 14 accesses the file server 2, and using the authentication information, logs into the file server 2 (step 310). When logging into the file server 2 has been successfully performed, the instruction sheet engine 10 acquires the received data stored as a file in the storage section (step 311), and stores the acquired file in the file server 2 (step 312).

In this example, which has been described with reference to FIG. 5, the authentication information request acquisition section 61 possessed by the client 6 is equivalent to the mail client, and the authentication information input section 62 is equivalent to the web browser. Therefore, in this example, the client 6 need not use special application software, and can utilize general-purpose application software.

In addition, the system may be adapted such that the input of the authentication information is sent to the device 1 as a reply to the authentication information request mail, and in this case, an apparatus which is capable of processing an electronic mail can be utilized as the client 6.

In addition, herein, the above description has been made on the assumption that the authentication information which has been inputted by the user, the possessor of the job, is passed to the instruction sheet engine 10 as it is, however, by utilizing the digest authentication as defined by the HTTP (Hyper Text Transfer Protocol), the authentication can be achieved without the authentication information itself being passed to the instruction sheet engine 10. In this case, the instruction sheet engine 10 sends an authentication request to the server (for example, the file server 2) which authentication has become necessary, and from the server, receives a nonce. The instruction sheet engine 10 sends the authentication request to the user, the possessor of the job together with the nonce. On the user side, the information generated from the nonce and the authentication information is sent to the instruction sheet engine 10, whereby the authentication information can be more safely received and sent to the instruction sheet engine 10.

### Exemplary Embodiment 2

In the Exemplary Embodiment 1, as a specific example about request for the authentication information by the instruction sheet engine 10, and input of the authentication information from the client 6, the case in which an electronic mail is utilized has been explained, however, in the Exemplary Embodiment 2, the case in which the client 6 is caused to operate the authentication agent as software corresponding to the instruction sheet engine 10 will be described. In case where the authentication agent is used, communications between the device 1 and the client 6 are performed by utilizing a protocol generally utilized in the network, such as SOAP (Simple Object Access Protocol), or the like.

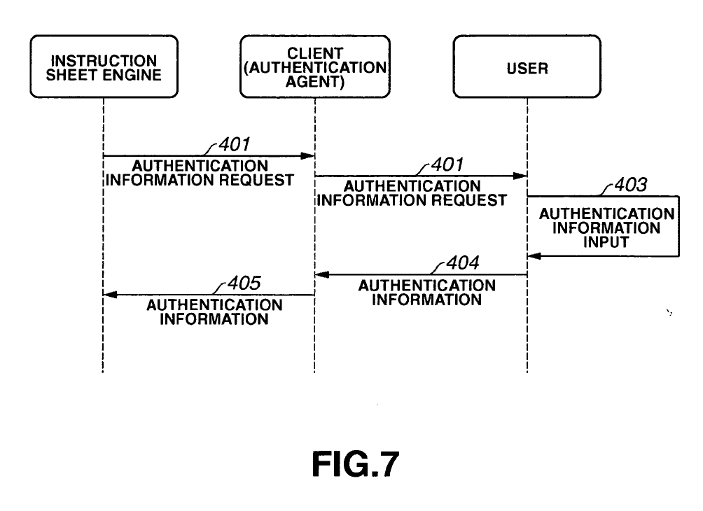

FIG. 7 is a diagram illustrating the flow of information sent and received in implementation of the instruction sheet in Exemplary Embodiment 2.

In the device 1, when a facsimile processing section (not shown) receives an image, it stores, on the basis of the instruction of the sender thereof, the received data as a file in the storage region for the user in which a storage section (not shown) is provided. When this storage of the received data in the storage section meets the requirement for implementing a particular instruction sheet stored in an instruction sheet storage section (not shown) (one region of the storage section in which the received data has been stored), the instruction sheet engine 10 reads out the instruction sheet and implements the instruction sheet read out.

In the course of this implementation of the instruction sheet, when the authentication information acquisition determination section 11 determines that there is the need for acquiring the authentication information, the authentication information request section 12 requests the authentication agent in the client 6 to input the authentication information, according to the statement as given in the instruction sheet (step 401).

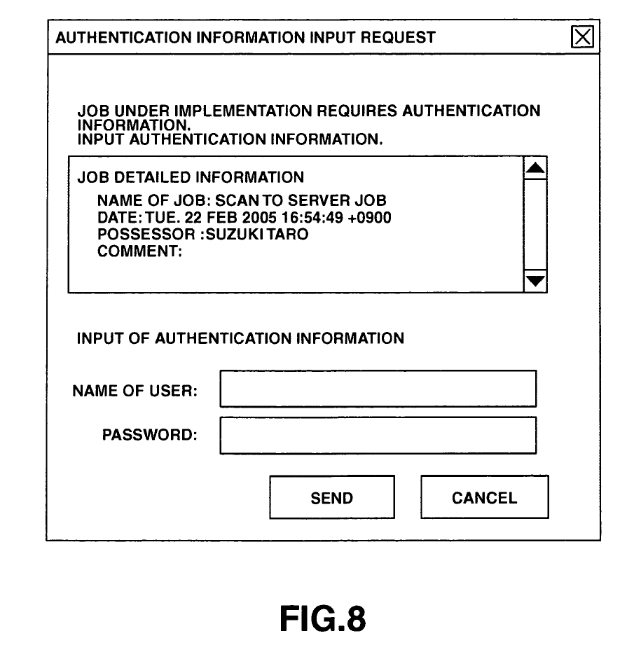

On the other hand, the authentication agent which has received the input request for the authentication information provides a pop-up display, for example, that as shown in FIG. 8, on the display screen (not shown) in the client 6, requesting the user, the possessor of the job, to input the authentication information (step 402). And, when the user inputs the authentication information on this pop-up screen (step 403), the authentication agent acquires the authentication information inputted (step 404), and sends this to the authentication information acquisition section 13 (step 405).

When the authentication information acquisition section 13 acquires the authentication information, the authentication implementation section 14 accesses the file server 2, and using the authentication information, logs into the file server 2. When logging into the file server 2 has been successfully performed, the instruction sheet engine 10 acquires the received data stored as a file in the storage section, and stores the acquired file in the file server 2.

In addition, in case where the authentication agent is utilized, the user previously sets, for the authentication agent, the information for a reliable instruction sheet engine 10 and the authentication information, whereby inputting the authentication information on each occasion can be avoided. The information for an instruction sheet engine 10 is, for example, the client certificate for the instruction sheet engine 10.

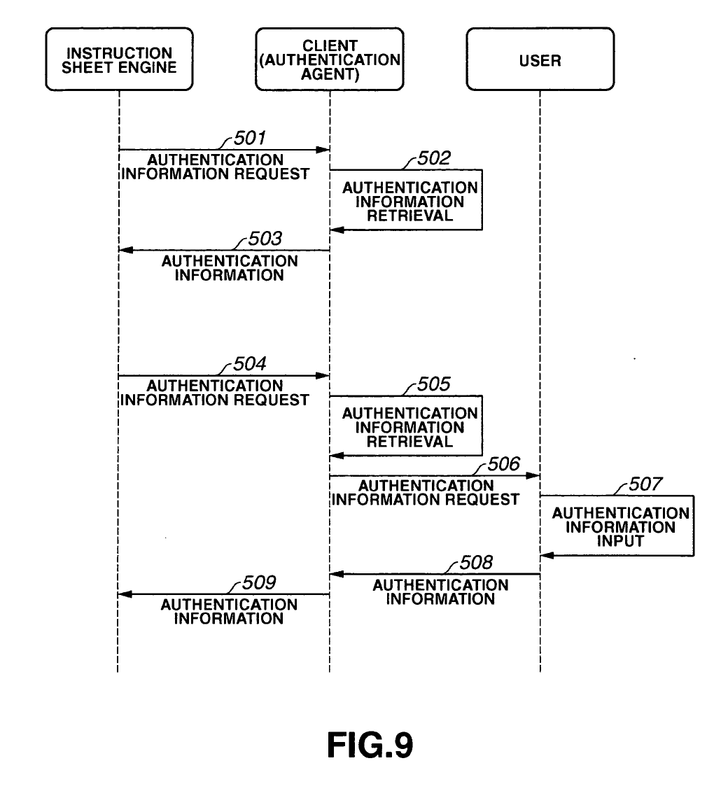

FIG. 9 is a diagram illustrating the flow of information sent and received in implementation of the instruction sheet in case where the authentication information is set in the authentication agent.

In the course of the implementation of the instruction sheet by the instruction sheet engine 10, when the authentication information acquisition determination section 11 determines that there is the need for acquiring the authentication information, the authentication information request section 12 requests the authentication agent in the client 6 to input the authentication information, according to the statement as given in the instruction sheet (step 501).

In case where the instruction sheet engine 10 is reliable, and the information for the instruction sheet engine 10 has been set, the authentication agent which has received the input request for the authentication information retrieves the previously set authentication information (step 502), and notifies the instruction sheet engine 10 of the authentication information retrieved (step 503).

Likewise, in the course of the implementation of the instruction sheet by the instruction sheet engine 10, when the authentication information acquisition determination section 11 determines that there is the need for acquiring the authentication information, the authentication information request section 12 requests the authentication agent in the client 6 to input the authentication information, according to the statement as given in the instruction sheet (step 504).

In case where the instruction sheet engine 10 is reliable, and the information for the instruction sheet engine 10 has been set, the authentication agent which has received the input request for the authentication information retrieves the previously set authentication information (step 505), however, in case where the pertinent authentication information has not been set, or in case where the information for the instruction sheet engine 10 has not been set (in this case, the processing at step 505 will not be implemented), the authentication agent provides a pop-up display, for example, that as shown in FIG. 9 on the display screen (not shown) in the client 6, requesting the user, the possessor of the job, to input the authentication information (step 506). And, when the user inputs the authentication information on this pop-up screen (step 507), the authentication agent acquires the authentication information inputted (step 508), and sends this to the authentication information acquisition section 13 (step 509).

In case where the authentication agent is utilized, by recording all the processings which have been implemented by the authentication agent as a log, the user can manage the processings on the basis of the instruction sheet.

### Exemplary Embodiment 3

In Exemplary Embodiment 3, the case in which the authentication information request section 12 and the authentication information acquisition section 13 which have been possessed by the instruction sheet engine 10 in Exemplary Embodiment 1 and Exemplary Embodiment 2 are disposed on the side of that which provides service, for example, the file server 2, the application service server 3, or the like will be described.

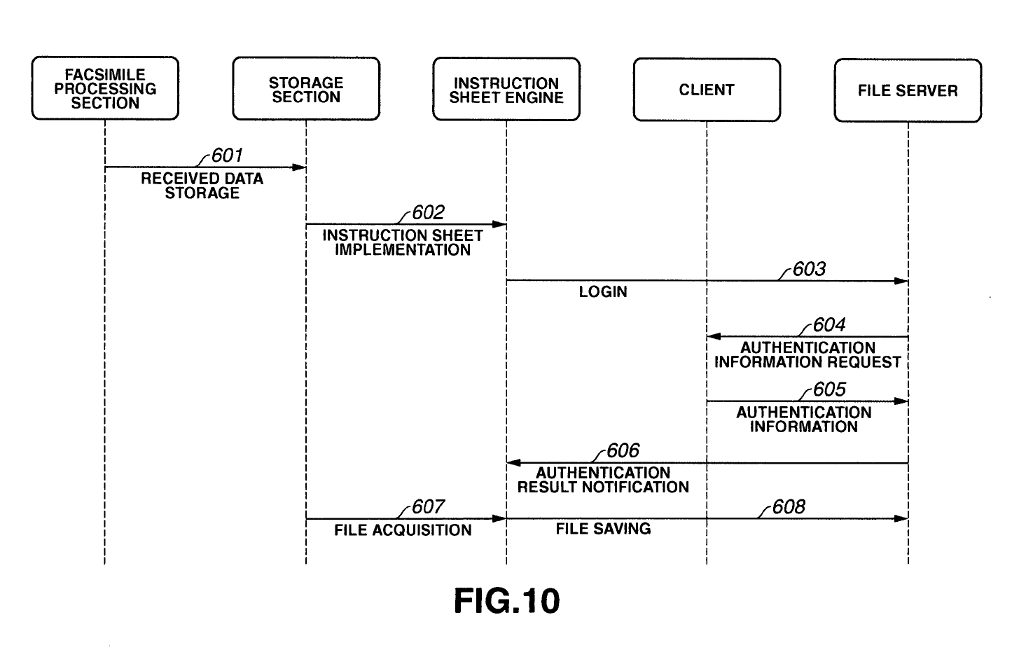

FIG. 10 is a flowchart illustrating the flow of the information sent and received in implementation of the instruction sheet in Exemplary Embodiment 3.

In the device 1, when a facsimile processing section (not shown) receives an image, it stores, on the basis of the instruction of the sender thereof, the received data as a file in the storage region for the user in which a storage section (not shown) is provided (step 601). When this storage of the received data in the storage section meets the requirement for implementing a particular instruction sheet stored in an instruction sheet storage section (not shown) (one region of the storage section in which the received data has been stored), the instruction sheet engine 10 reads out the instruction sheet and implements the instruction sheet read out (step 602).

In the course of this implementation of the instruction sheet, when the authentication information acquisition determination section 11 determines that there is the need for acquiring the authentication information, the authentication implementation section 14 logs into the file server 2 (step 603). In the file server 2, when a login by the authentication implementation section 14 occurs, the authentication information request section (equivalent to the authentication information request section 12 disposed in the file server 2) requests inputting the authentication information of the client 6 which is utilized by the user, the possessor of the job (step 604). When, in response to this input request for the authentication information, the user, the possessor of the job, inputs the authentication information, the authentication information acquisition section (equivalent to the authentication information acquisition section 13 disposed in the file server 2) acquires this (step 605).

When the authentication information acquisition section acquires the authentication information, the file server 2 performs authentication for the login at the step 603 on the basis of the authentication information acquired, and notifies the instruction sheet engine 10 of the result thereof (step 606).

When logging into the file server 2 has been successfully performed, the instruction sheet engine 10 acquires the received data stored as a file in the storage section (step 607), and stores the acquired file in the file server 2 (step 608).

The specific example about request for the authentication, and input of the authentication information from the client 6 is the same as in Exemplary Embodiment 1 and Exemplary Embodiment 2, thus the explanation is omitted.

The foregoing description of the exemplary embodiments of the present invention has been provided for the purpose of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling other skilled in the art to understand the invention for various embodiments and with the various modifications as are suited to the particular use contemplated. It is intended that the scope of the invention be defined by the following claims and their equivalents.

What is claimed is:

1. An authentication apparatus which, during processing a job which is initiated according to occurrence of an event and is performed based on an instruction sheet, implements an authentication processing required for processing the job, comprising:
a determination section that determines whether authentication is required for processing the job;
a request section that, in case where the determination section determines that the authentication is required, requests a possessor of the job to input authentication information;
a reception that, according to the request by the request section, receives the authentication information which is inputted by the possessor; and
an implementation section that, on the basis of the authentication information which the reception receives, implements the authentication processing.

2. The authentication apparatus of claim 1, wherein the event is stated in the instruction sheet together with at least processing contents of the job to be implemented according to the occurrence of the event, the possessor of the job, and a method for requesting the possessor to input the authentication information.

3. The authentication apparatus of claim 1, wherein
the request section sends an electronic mail to the possessor of the job for requesting inputting the authentication information, and
the reception receives the authentication information which is inputted in an electronic mail of reply to the electronic mail which is sent by the request section.

4. The authentication apparatus of claim 1, wherein
the request section sends, to the possessor of the job, an electronic mail giving a URL which provides an input destination for the authentication information, for requesting inputting the authentication information, and
the reception receives the authentication information which is inputted on a web page shown at the URL given in the electronic mail which the request section sends.

5. The authentication apparatus of claim 1, wherein
the request section requests an agent to input the authentication information, the agent being realized by a program which operates in correspondence to the request section in a client device which is used by the possessor of the job, and
the reception receives the authentication information inputted into the agent.

6. An authentication method which, during processing a job which is initiated according to occurrence of an event and is performed based on an instruction sheet, implements an authentication processing required for processing the job, the method comprising:
determining whether authentication is required for processing the job;
in case it is determined that the authentication is required, requesting a possessor of the job to input authentication information;
receiving the authentication information which the possessor inputs according to the request; and
on the basis of the authentication information received, implementing the authentication processing.

7. The authentication method of claim 6, wherein the event is stated in the instruction sheet together with at least processing contents of the job to be implemented according to the occurrence of the event, the possessor of the job, and a method for requesting the possessor to input the authentication information.

8. The authentication method of claim 6, wherein
the request for inputting the authentication information is carried out by sending an electronic mail to the possessor of the job, and
the reception of the authentication information is carried out by receiving an electronic mail of reply to the electronic mail.

9. The authentication method of claim 6, wherein
the request for inputting the authentication information is carried out by sending, to the possessor of the job, an electronic mail giving a URL which provides an input destination for the authentication information, and
the reception of the authentication information is carried out by acquiring the authentication information which is inputted on a web page shown at the URL.

10. The authentication method of claim 6, wherein
the request for inputting the authentication information is made to an agent realized by a program which operates in a client device which is used by the possessor of the job, and
the reception of the authentication information is carried out by acquiring the authentication information which is inputted into the agent.

11. A computer readable recording medium storing an authentication program causing a computer to execute, during processing a job which is initiated according to occurrence of an event and is performed based on an instruction sheet, an authentication processing required for processing the job, the authentication processing comprising:
determining whether authentication is required for processing the job;
in case it is determined that the authentication is required, requesting a possessor of the job to input authentication information;
receiving the authentication information which the possessor inputs according to the request; and
on the basis of the authentication information received, implementing the authentication processing.

12. The computer readable recording medium storing the authentication program according to claim 11, wherein the event is stated in the instruction sheet together with at least processing contents of the job to be implemented according to the occurrence of the event, the possessor of the job, and a method for requesting the possessor to input the authentication information.

13. The computer readable recording medium storing the authentication program according to claim 11, wherein
the request for inputting the authentication information is carried out by sending an electronic mail to the possessor of the job, and
the reception of the authentication information is carried out by receiving an electronic mail of reply to the electronic mail.

14. The computer readable recording medium storing the authentication program according to claim 11, wherein
the request for inputting the authentication information is carried out by sending, to the possessor of the job, an electronic mail giving a URL which provides an input destination for the authentication information, and
the reception of the authentication information is carried out by acquiring the authentication information which is inputted on a web page shown at the URL.

15. The computer readable recording medium storing the authentication program according to claim 11, wherein
the request for inputting the authentication information is made to an agent realized by a program which operates in a client device which is used by the possessor of the job, and
the reception of the authentication information is carried out by acquiring the authentication information which is inputted into the agent.

16. A computer data signal embodied in a carrier wave that represents a program for enabling a computer to perform, during processing a job which is initiated according to occurrence of an event and is performed based on an instruction sheet, an authentication processing required for processing the job, the authentication processing comprising:
determining whether authentication is required for processing the job;
in case it is determined that the authentication is required, requesting a possessor of the job to input authentication information;
receiving the authentication information which the possessor inputs according to the request; and
on the basis of the authentication information received, implementing the authentication processing.

17. The computer data signal according to claim 16, wherein the event is stated in the instruction sheet together with at least processing contents of the job to be implemented according to the occurrence of the event, the possessor of the job, and a method for requesting the possessor to input the authentication information.

18. The computer data signal according to claim 16, wherein
the request for inputting the authentication information is carried out by sending an electronic mail to the possessor of the job, and
the reception of the authentication information is carried out by receiving an electronic mail of reply to the electronic mail

19. The computer data signal according to claim 16, wherein
the request for inputting the authentication information is carried out by sending, to the possessor of the job, an electronic mail giving a URL which provides an input destination for the authentication information, and
the reception of the authentication information is carried out by acquiring the authentication information which is inputted on a web page shown at the URL.

20. The computer readable recording medium according to claim 16, wherein
the request for inputting the authentication information is made to an agent realized by a program which operates in a client device which is used by the possessor of the job, and
the reception of the authentication information is carried out by acquiring the authentication information which is inputted into the agent.
